(19) United States
(12) Patent Application Publication
(10) Pub. No.: US 2002/0127942 A1
(43) Pub. Date: Sep. 12, 2002

(54) Method of fabricating capillary discharge plasma display panel using combination of laser and wet etchings

(75) Inventors: Steven Kim, Harrington Park, NJ (US); Sooho Park, Rutherford, NJ (US); Geun-Young Yeom, Seoul (KR); Young-Joon Lee, Seoul (KR)

Correspondence Address: MORGAN LEWIS & BOCKIUS LLP, 1111 PENNSYLVANIA AVENUE NW, WASHINGTON, DC, 20004, US

(73) Assignee: Plasmion Displays, LLC.

(21) Appl. No.: 09/976,276

(22) Filed: Oct. 15, 2001

Related U.S. Application Data
(60) Provisional application No. 60/248,005, filed on Nov. 14, 2000.

(51) Int. Cl. H01J 9/00; C03C 25/68

(52) U.S. Cl. 445/24; 216/94

(57) ABSTRACT

A method of fabricating a plasma display panel having a substrate includes the steps of forming an electrode on the substrate, forming a dielectric layer on the substrate including the electrode, forming at least one capillary in the dielectric layer using dry-etching, wherein the capillary and the electrode are separated apart by a portion of the dielectric layer, and sequentially removing the portion of dielectric layer to expose the electrode through the capillary.

This application claims the benefit of a provisional application, entitled “Method of Fabrication of Capillary Electrode Discharge Plasma Display Panel Using Laser Drilling,” which was filed on Nov. 14, 2000, and assigned Provisional Application No. 60/248,005, which is hereby incorporated by reference.

### BACKGROUND OF THE INVENTION

1. Field of the Invention

The present invention relates to a plasma display panel, and more particularly, to a method of fabricating a capillary discharge plasma display panel using a combination of laser and wet etchings. Although the present invention is suitable for a wide scope of applications, it is particularly suitable for forming capillaries in the plasma display panel, thereby generating a high-density plasma discharge.

2. Discussion of the Related Art

A capillary discharge plasma display panel (CDPDP) is disclosed in U.S. patent application Ser. No. 09/108,403, filed by the applicant of the present invention, as shown in FIG. 1. The CDPDP is suitable for discharge of ultraviolet rays at a high density in an alternating current mode or a direct current mode. The CDPDP have a driving voltage and a turn-on time to be greatly reduced comparing to other types of plasma display panels.

The aforementioned capillary discharge plasma display panel (CDPDP) includes a first substrate 11, a second substrate 12, a first electrode 13 formed on the first substrate 11, as shown in FIG. 1. A second electrode 14 is formed on the second substrate 12 and a pair of barrier ribs 15 connect the first substrate 11 and the second substrate 12. A discharge region 16 is defined between the first substrate 11 and the second substrate 12 by the barrier ribs 15. A dielectric layer 17 is formed on the first substrate 11 including the first electrode 13. The dielectric layer 17 has at least one or more capillaries 18 for providing a steady state discharge of ultraviolet (UV) rays within the discharge region 16. The capillary 18 exposes the first electrode 13 toward the discharge region 16. The aforementioned CDPDP generates a high-density plasma. The plasma begins to be generated in the capillaries 18. A density and a diameter of the capillaries maybe varied to optimize discharge characteristics.

Still referring to FIG. 1, one of laser etching, wet etching, and dry etching may be used in forming the capillaries in the dielectric layer 17. However, it is required to obtain precise etching conditions such as a dielectric material, a mask material, an etching method, and process conditions. If an etching process is not executed by using the optimum conditions, it is almost impossible to form desired capillaries in the PDP.

The above-mentioned methods of forming capillaries have drawbacks as follows. First of all, it takes too much time in the laser etching method because the laser etching is inherently slow. In addition, the capillaries cannot be formed uniformly using the laser etching because the laser etching is a physical etching method that provides no etching selectivity. In other words, it is often observed that some capillaries are formed in the dielectric layer while others are not formed as desired.

In the wet etching method, since the wet etching has isotropic etching characteristic, it is virtually impossible to obtain a diameter of the capillary in the exactly intended micrometer unit. Accordingly, it is required to obtain optimum etching conditions by systematically repeating experiments.

### SUMMARY OF THE INVENTION

Accordingly, the present invention is directed to a method of fabricating a capillary discharge plasma panel using a combination of laser and wet etchings that substantially obviates one or more of the problems due to limitations and disadvantages of the related art.

An object of the present invention is to provide a method of fabricating a capillary discharge plasma panel using a combination of laser and wet etchings to form capillaries, thereby improving yield as well as reducing a production cost.

Additional features and advantages of the invention will be set forth in the description that follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages in accordance with the purpose of the present invention, as embodied and broadly described, a method of fabricating a plasma display panel having a substrate includes the steps of forming an electrode on the substrate, forming a dielectric layer on the substrate including the electrode, forming at least one capillary in the dielectric layer using dry-etching, wherein the capillary and the electrode are separated apart by a portion of the dielectric layer, and sequentially removing the portion of dielectric layer to expose the electrode through the capillary.

In another aspect of the present invention, a method of fabricating a plasma display panel having first and second substrates includes the steps of forming a first electrode on the first substrate, forming a dielectric layer on first the substrate including the electrode, cleaning the first substrate layer on the first substrate, forming at least one capillary in the dielectric layer using laser etching, wherein the capillary and the electrode are separated apart by a portion of the dielectric layer, sequentially removing the portion of dielectric layer to expose the electrode through the capillary, and assembling the first substrate with the second substrate to complete the plasma display panel.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention.

In the drawings:

FIG. 1 is a cross-sectional view illustrating a capillary discharge plasma display panel disclosed in U.S. patent application Ser. No. 09/108,403;

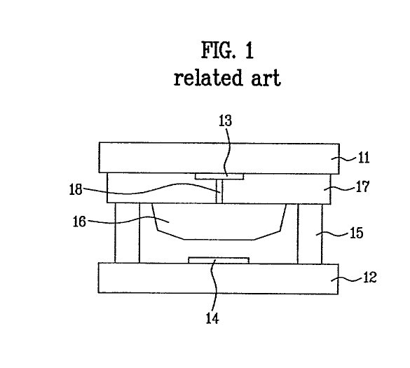

FIG. 2 is a schematic diagram of laser optics used for laser etching in forming a capillary in the dielectric layer in the present invention;

FIG. 3 is a cross-sectional view illustrating a capillary partially formed in the dielectric layer after completion of the laser etching process in the present invention;

FIGS. 4A to 4D are cross-sectional views illustrating the process steps of fabricating a capillary discharge plasma display panel in the present invention.

FIG. 5 is an SEM photograph of the PbO layer etched by the laser etching method in FIG. 3;

FIG. 6 is an SEM photograph of the etched PbO layer exposing an electrode when the PbO layer is etched in HNO₃+CH₃COOH+deionized water (1:1:50) as a wet etching solution; and

FIG. 7 is an SEM photograph of the etched PbO layer when the PbO layer is etched in HNO₃+CH₃OH+deionized water (1:1:50) as a wet etching solution.

### DETAILED DESCRIPTION OF THE PREFERRED EMBODIMENTS

Reference will now be made in detail to the preferred embodiments of the present invention, examples of which are illustrated in the accompanying drawings.

A dielectric layer used in a capillary discharge plasma display panel (CDPDP) must have a high dielectric constant in the frequency range of 10 kHz to 250 kHz as well as have a high breakdown voltage. In the present invention, PbO is chosen as a dielectric layer because it has suitable characteristics. However, the PbO layer is difficult to be patterned as desired. Specifically, since PbO has a low vapor pressure, an etching rate is very low. Moreover, a thickness of at least 10 μm is required in order to properly form capillaries in the PbO layer. As well known, it is difficult to etch a PbO layer having such a thickness. Moreover, to pattern the PbO layer, a hard mask is generally required. A thickness of the hard mask should be proportionally increased with that of the dielectric layer. Accordingly, it is difficult to pattern the hard mask only. Thus, the mask layer and its thickness are important factors in forming the capillaries. Also, a method of etching the PbO by using a prefabricated mask is very important for forming desired capillaries.

In the present invention, a laser etching method and a wet etching method are sequentially performed in forming capillaries in the dielectric layer without using a hard mask on the PbO layer.

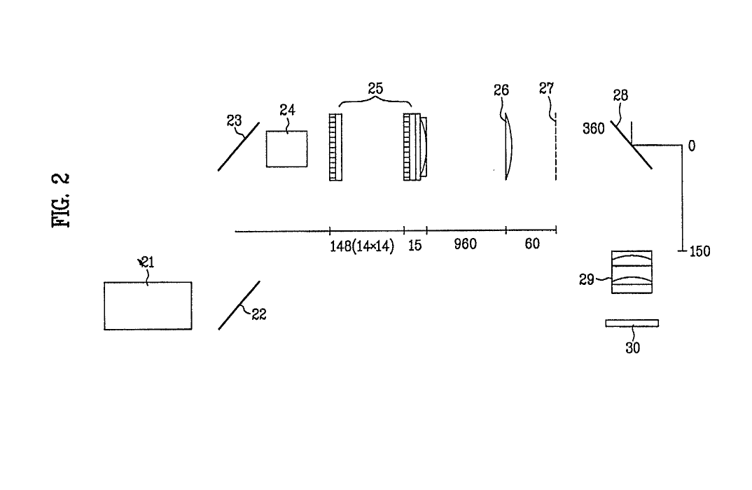

FIG. 2 is a schematic diagram of the laser optics used for laser etching in partially forming capillaries in the dielectric layer. The laser optics comprises a KrF laser 21, first and second mirrors 22 and 23, an attenuator 24, a homegenizer 25, a field lens 26, a mask 27, a third mirror 28, and an objective 29. A substrate 30 is positioned below the objective 29. Laser etching conditions are as follows: laser wavelength of 248 nm, 5× demagnification, energy density on substrate of 2.7 J/cm², and repetition rate of 20 Hz (pulse/sec).

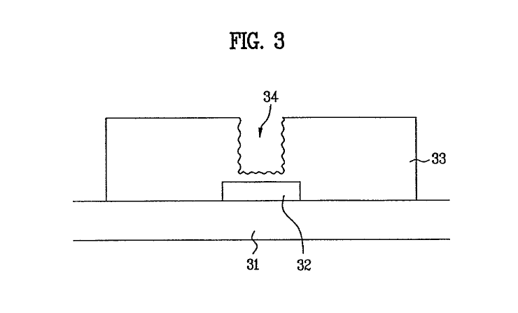

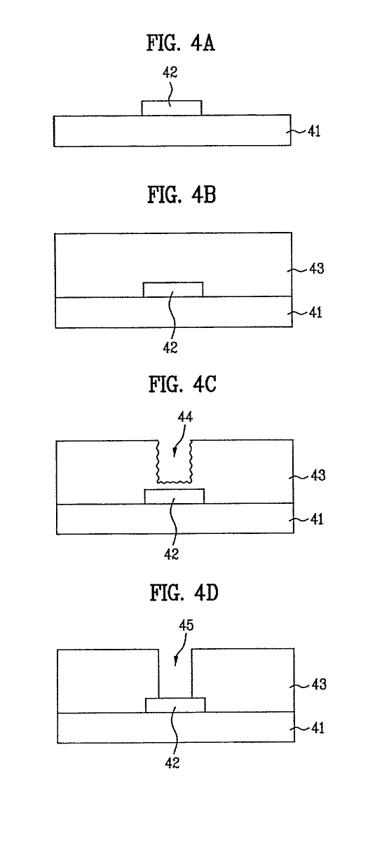

FIG. 3 is a cross-sectional view of a first substrate 31 after a laser etching process is completed. In this process, a capillary 34 is partially formed in a dielectric layer 33. As shown in the drawing, the capillary 34 does not expose a first electrode 32. For example, PbO is selected as the dielectric layer 33 in the present invention. Since the surface of the capillary 34 is not smooth, an additional process is required to obtain a desired shape of the capillary 34. About a 5 μm thickness of the dielectric layer 33 in the capillary 34 is remained on the first electrode 32. Subsequently, the remaining dielectric layer 33 is dipped into a wet etching solution to remove a portion of the dielectric layer. Thus, the first electrode 32 is exposed by the capillary (shown in FIG. 4D). In this process, no mask layer is required in completing the capillary. Alternatively, a photoresist may be formed on the dielectric layer 33 before the wet etching.

FIGS. 4A to 4D are cross-sectional views illustrating an overall process steps of fabricating a CDPDP using a combination of laser and wet etching.

In FIG. 4A, a first electrode 42 (for example, an Ag layer) is formed on a first substrate 41. A dielectric layer 43 is deposited on the first substrate 41 including the first electrode 42, as shown in FIG. 4B. By using a laser etching process, a capillary 44 is formed in the dielectric layer 43 in FIG. 4C. Thereafter, the capillary 44 is further etched by a wet etching method to form a capillary 45, thereby exposing a portion of the first electrode 42. In the above process, prior to the laser etching, the surface of the dielectric layer 43 may be pre-cleaned by a successive dipping in acetone, methanol, and deionized water using an ultrasonic cleaner for 3 to 10 minutes.

A detailed process using both the laser etching method and the wet etching method are explained as follows.

In determined an etching condition, various trials are performed and summarised in Table 1. More specifically, Table 1 is a list for etching solutions, etching rates of PbO, an reactivity of the solutions with materials other than PbO, and remarks.

TABLE 1

| | | | Reactivity of solutions | | | | |
|---|---|---|---|---|---|---|---|
| | | | with materials other than | | | | |
| | | | PbO | | | | |
| | | Etching rate of | | | P | | |
| # | Etch conditions | PbO (Å/min) | Ag | ITO | R | Glass | Remarks |
| 1 | In the order of | 20,000 | O | X | X | X | This etching |
| | HNO₃(66% dilution), | | | | | | condition reacts |
| | H₂O rinse, CH₃OH | | | | | | with Ag. |
| | rinse, and dry | | | | | | [Reference: |
| | | | | | | | Thin Film |
| | | | | | | | Process (John |
| | | | | | | | L. Vossen & |
| | | | | | | | Wernwer kern) |
| 2 | HNO₃ + CH₃COOH = | 6,000 | Δ | X | Δ | X | |
| | 2:1 | | | | | | |
| 3 | HNO₃ + CH₃COOH = | 5,043 | Δ | X | Δ | X | |
| | 1:1 | | | | | | |
| 4 | HNO₃ + CH₃COOH + | 159,220 | X | X | X | X | |
| | DI water = | | | | | | |
| | 1:1:5 | | | | | | |
| 5 | HNO₃ + CH₃OH + DI | 76,300 | X | X | X | X | |
| | water = | | | | | | |
| | 1:1:5 | | | | | | |
| 6 | HNO₃ + CH₃COOH + | 38,700 | X | X | X | X | |
| | DI water = | | | | | | |
| | 1:1:50 | | | | | | |
| 7 | HNO₃ + CH₃OH + DI | 37,450 | X | X | X | X | |
| | water = | | | | | | |
| | 1:1:50 | | | | | | |

Row No. 1 in Table 1 shows wet etching conditions for PbO disclosed in “A Thin Film Process” published by John L. Vossen and Werner Kern, Academic Press Inc. (1978). According to this condition, PbO is etched with a wet solution of HNO₃ (66% diluted) and then rinsed with H₂O. Subsequently, the PbO is rinsed with CH₃OH and dried. Under this condition, however, an Ag layer buried by the PbO is reacted with the solutions. Accordingly, there is a problem in using the solution of row No. 1. In Table 1, PR denotes a photoresist, Ag denotes silver used as an electrode while ITO stands for indium thin oxide. As show in Table 1, it has been found that the solutions of Nos. 1 to 3 are not suitable because the Ag layer or the ITO layer is deformed, or the PbO layer is seriously deformed. On the other hand, the solutions of Nos. 6 and 7 in Table 1 are the most suitable for wet-etching the PbO layer. Although conditions for row Nos. 4 and 5 are acceptable in terms of reactivity, their etching rates are too fast to be used. Therefore, it is determined that the best solutions for wet etching are HNO₃+CH₃OH+DI water (1:1:50) and HNO₃+CH₃COOH+DI water (1:1:50). In addition, deionized (DI) water is used for dilution. A mixture ratio of the two solutions may be varied depending on their usage. In Table 1, to minimize isotropic etching that is a drawback of the wet etching method, a etching time for a 5 μm thick PbO layer has been set to be one minute or less. For reference, when the solutions of Nos. 1 to 7 in Table 1 are used, etching rates per minute (Å/min) of the PbO layer are 20,000, 6000, 5,043, 159,220, 76,300, 38,700, and 37,450, respectively.

Table 2 lists the results when the PbO layer is etched using the two selected solutions. When the PbO layer is etched using HNO₃+CH₃OH+DI water (1:1:50) as a wet etching solution, an etching rate per minute is 3.745 μm. Thus, an estimated time required etching the PbO layer of 5 μm is about 1 minute and 20 seconds. A selectivity of the Ag layer is infinite for three hours, and a surface morphology is rarely varied.

TABLE 2

| | | Estimated | | |
|---|---|---|---|---|
| | | time to | Selectivity | Surface |
| Wet etching | Etching rate | etch PbO | of Ag | morphology |
| solutions | (μm/min) | of 5 μm | electrode | variation |
| HNO₃ + | 3.745 | 1 minute and | 4 for 3 hours | Some |
| CH₃OH + | | 20 seconds | | |
| DI water | | | | |
| (methanol) | | | | |
| (1:1:50) | | | | |
| HNO₃ + | 3.87 | 1 minute and | 4 for 3 hours | Some |
| CH₃CO | | 18 seconds | | |
| OH + DI water | | | | |
| (acetic acid) | | | | |
| (1:1:50) | | | | |

Meanwhile, in Table 2, when the PbO layer is etched using HNO₃+CH₃COOH+DI water (1:1:50) as an etching solution, an etching rate per minute is 3.87 μm. Thus, an estimated time required etching the PbO layer of 5 μm is about 1 minute and 18 seconds. A selectivity of the Ag layer is infinite for three hours and a surface morphology is rarely varied.

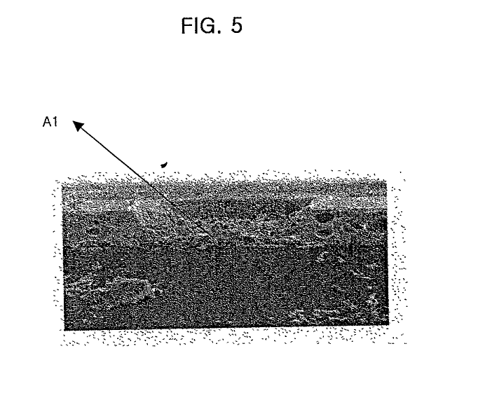

FIG. 5 is an SEM photograph of the PbO layer etched by a laser etching method in the present invention. As shown in the region Al, the surface of the PbO remaining in a hole after the laser etching becomes rough. The Ag layer below the PbO layer is not exposed yet.

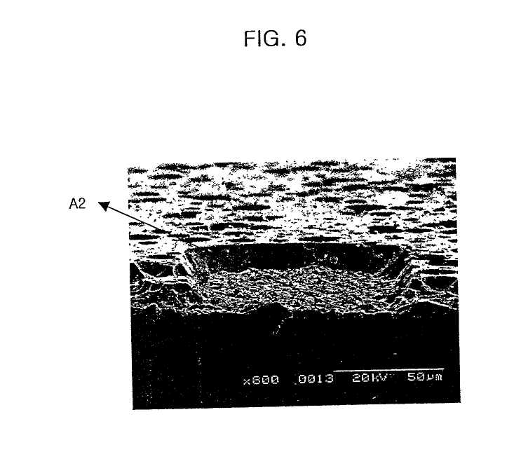

FIG. 6 is an SEM photograph of the PbO layer in the hole that is wet-etched to have a thickness of about 7.49 μm by dipping into HNO₃+CH₃COOH+DI water (1:1:50) as a wet etching solution for two minutes. The region A2 shows that the PbO layer is further etched after the laser etching process so that a capillary is formed and the surface of the Ag layer is uniformly exposed through the capillary.

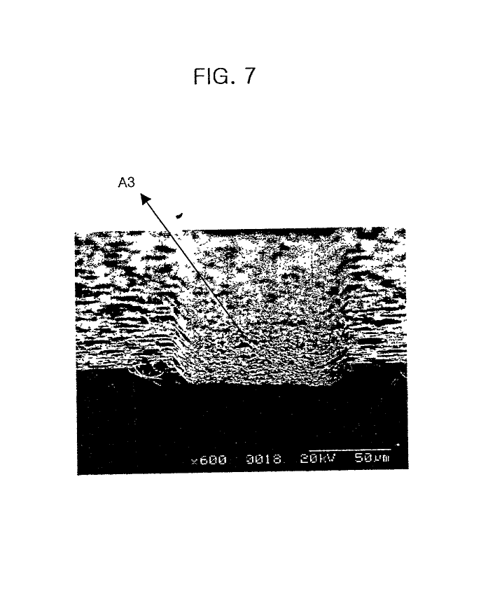

FIG. 7 is an SEM photograph of the PbO layer that is etched to have a thickness of about 7.74 μm by dipping the PbO layer into HNO₃+CH₃OH+DI water (1:1:50) as a wet etching solution for two minutes. The region A3 shows that the PbO film is further etched after the laser etching process. As shown in FIG. 7, a capillary is formed and the surface of the Ag layer is uniformly exposed through the capillary.

The above-explained process steps are applicable to any kinds of capillary discharge plasma display panels. As described above, the method of fabricating a plasma display panel has the following advantages.

Since a laser etching method is used in the initial etching process, there is no limit to process in the thickness of the dielectric layer. In addition, capillaries are formed within the dielectric layer without damaging an electrode by wet etching. Unlike a dry etching method, the wet etching method provides almost infinite selectivity by choosing a proper solution. Accordingly, the capillaries are formed without damaging the electrode buried below the dielectric layer. Further, although the surface of the dielectric layer is not smooth by the laser etching method only, the rough surface becomes smooth by the wet etching method. Therefore, the wet etching method causes a post cleaning effect.

It will be apparent to those skilled in the art that various modifications and variations can be made in the method of fabricating a capillary discharge plasma display panel using a combination of laser and wet etchings of the present invention without departing from the spirit or scope of the inventions. Thus, it is intended that the present invention covers the modifications and variations of this invention provided they come within the scope of the appended claims and their equivalents.

What is claimed is:

1. A method of fabricating a plasma display panel having a substrate, the method comprising the steps of:
forming an electrode on the substrate;
forming a dielectric layer on the substrate including the electrode;
forming at least one capillary in the dielectric layer using dry-etching, wherein the capillary and the electrode are separated apart by a portion of the dielectric layer; and
sequentially removing the portion of dielectric layer to expose the electrode through the capillary.

2. The method according to claim 1, wherein the dielectric layer is formed of PbO.

3. The method according to claim 1, wherein the portion of the dielectric layer has a thickness of at least 5 μm.

4. The method according to claim 1, wherein the step of sequentially removing the portion of dielectric layer is performed by wet-etching.

5. The method according to claim 1, wherein the etching solution is selected from either HNO₃+CH₃OH+DI water (1:1:50) or HNO₃+CH₃COOH +deionized water (1:1:50).

6. The method according to claim 1, further comprising the step of pre-cleaning the substrate before the step of forming at least one capillary in the dielectric layer.

7. The method according to claim 6, wherein the step of pre-cleaning the substrate includes successively cleaning the substrate in acetone, methanol, and deionized water using an ultrasonic cleaner for 3 to 10 minutes.

8. The method according to claim 1, wherein the electrode is formed of silver.

9. The method according to claim 1, wherein the dry-etching includes laser etching.

10. A method of fabricating a plasma display panel having first and second substrates, the method comprising the steps of:
forming a first electrode on the first substrate;
forming a dielectric layer on the first substrate including the first electrode;
cleaning the surface of the first substrate;
forming at least one capillary in the dielectric layer using laser etching, wherein the capillary and the first electrode are separated apart by a portion of the dielectric layer;
sequentially removing the portion of dielectric layer to expose the first electrode through the capillary; and
assembling the first substrate with the second substrate to complete the plasma display panel.

11. The method according to claim 10, wherein the dielectric layer is formed of PbO.

12. The method according to claim 10, wherein the portion of the dielectric layer has a thickness of at least 5 μm.

13. The method according to claim 10, wherein the step of sequentially removing the portion of dielectric layer is performed by wet-etching.

14. The method according to claim 10, wherein the etching solution is selected from either HNO₃+CH₃OH+DI water (1:1:50) or HNO₃+CH₃COOH+deionized water (1:1:50).

15. The method according to claim 10, wherein the step of cleaning the first substrate includes successively cleaning the first substrate in acetone, methanol, and deionized water using an ultrasonic cleaner for 3 to 10 minutes.

16. The method according to claim 10, wherein the electrode is formed of silver.
